(19) United States
(12) Patent Application Publication
(10) Pub. No.: US 2024/0217775 A1
(43) Pub. Date: Jul. 4, 2024

(54) ELEVATOR CONTROL

(71) Applicant: KONE Corporation, Helsinki (FI)

(72) Inventors: Juha-Matti KUUSINEN, Helsinki (FI); Jere VUORENALA, Helsinki (FI)

(73) Assignee: KONE Corporation, Helsinki (FI)

(21) Appl. No.: 18/604,995

(22) Filed: Mar. 14, 2024

Related U.S. Application Data
(63) Continuation of application No. PCT/EP2021/078629, filed on Oct. 15, 2021.

(51) Int. Cl. B66B 1/46

(52) U.S. Cl. CPC B66B 1/468; B66B 2201/103; B66B 2201/213; B66B 2201/232; B66B 2201/233; B66B 2201/243; B66B 2201/405; B66B 2201/4615; B66B 2201/4661

(57) ABSTRACT

According to an example embodiment, an apparatus for scheduling elevator transport in an elevator system comprising one or more elevators is provided. The apparatus may be configured to: obtain, for a plurality of passengers, a respective transport request for elevator transport using said one or more elevators, the transport request comprising at least respective indications of an origin floor, a destination floor and a requested transport time window; derive, in dependence of said plurality of transport requests, a transport schedule that includes a respective transport allocation for each of said plurality of passengers, wherein a transport allocation for a passenger is derived in accordance with the requested transport time window indicated for the respective passenger, in view of transport allocations derived for other passengers and in view of a transport capacity of said one or more elevators and wherein the transport allocation for a passenger comprises at least a scheduled transport time for the respective passenger; and operate said one or more elevators in accordance with the derived transport schedule.

### TECHNICAL FIELD

The example and non-limiting embodiments of the present invention relate to controlling operation of an elevator system and, in particular, scheduling of transport requests pertaining to transport by the elevator system.

### BACKGROUND

Typically, an elevator control system aims at scheduling transportation requests in a manner that optimizes one or more aspects of passenger service level in accordance with predefined scheduling rules in view of available transport capacity in the elevator system. Examples of aspects contributing the service level and hence considered in the scheduling of transportation request include a waiting time before entering an elevator car and/or transport time to the destination.

A user wishing to use the elevator system may place a call via a call giving device arranged e.g. close to an elevator of the elevator system, in an elevator lobby or in an area or space near the elevator lobby, which results in the call giving device issuing a transportation request to the elevator control system accordingly, which enters the transportation request to an transport schedule according to applicable scheduling rules and, consequently, controls the elevator system to provide an elevator car for picking up the user according to the transport schedule.

The scheduling rules of the elevator system are typically designed to accommodate certain traffic patterns and/or a certain number of passengers in view of the capacity of the available elevator cars, which is typically chosen based on the size and usage of the building in which the elevator system is operated. Moreover, the scheduling rules may further account for any security policies and administrative policies applicable in the building. Consequently, e.g. exceptionally high traffic volumes at peak hours or any changes in the usage of the building, in the number of people occupying or visiting the building and/or in security or administrative policies applied in the building typically result in changes in the traffic patterns and, consequently, scheduling of requests that relies on the scheduling rules designed on basis of the originally envisaged traffic patterns may result in degraded service level.

While a straightforward method address any service level issues arising from changes in the traffic pattern is to increase the transport capacity of the elevator system by introducing further elevator cars, this approach is not meaningful for addressing any temporary changes in the traffic patterns while in many scenarios it may be an unrealistic or even impossible choice. Further straightforward measures for addressing the service level issues arising from changes in the traffic pattern include denying access to at least some of the elevators of the elevator system in certain floors (e.g. in lower floors of a building), which might result in increased service level for those passengers that primarily travel between those floors that are open for the elevator service, while on the other and the service level for occupants of the non-serviced floor steeply degrades, typically resulting in changing the nature of the service level issues instead of truly addressing them.

A yet further measure for addressing the service level issues is redesign of the scheduling rules applied for deriving the transport schedule in order to optimize or improve overall service level of the elevator system under the constraints set by the available transport capacity of the elevator system in view of other factors having an effect to the access to the elevators (e.g. the security policies and/or administrative policies). However, designing the scheduling rules in a manner that results in reaching or even approximating a desired service level across the elevator-using occupants of the building is a non-straightforward task.

### SUMMARY

It is an object of the present invention to provide a technique that facilitates usage of the transport capacity of an elevator system in an efficient and flexible manner.

According to an example embodiment, an apparatus for scheduling elevator transport in an elevator system comprising one or more elevators is provided, the apparatus configured to: obtain, for a plurality of passengers, a respective transport request for elevator transport using said one or more elevators, the transport request comprising at least respective indications of an origin floor, a destination floor and a requested transport time window; derive, in dependence of said plurality of transport requests, a transport schedule that includes a respective transport allocation for each of said plurality of passengers, wherein a transport allocation for a passenger is derived in accordance with the requested transport time window indicated for the respective passenger, in view of transport allocations derived for other passengers and in view of a transport capacity of said one or more elevators and wherein the transport allocation for a passenger comprises at least a scheduled transport time for the respective passenger; and operate said one or more elevators in accordance with the derived transport schedule.

According to another example embodiment, a system for scheduling elevator transport in an elevator system comprising one or more elevators is provided, the system comprising the apparatus according to the example embodiment described in the foregoing.

According to another example embodiment, a method for scheduling elevator transport in an elevator system comprising one or more elevators is provided, the method comprising: obtaining, for a plurality of passengers, a respective transport request for elevator transport using said one or more elevators, the transport request comprising at least respective indications of an origin floor, a destination floor and a requested transport time window; deriving, in dependence of said plurality of transport requests, a transport schedule that includes a respective transport allocation for each of said plurality of passengers, wherein a transport allocation for a passenger is derived in accordance with the requested transport time window indicated for the respective passenger, in view of transport allocations derived for other passengers and in view of a transport capacity of said one or more elevators and wherein the transport allocation for a passenger comprises at least a scheduled transport time for the respective passenger; and operating said one or more elevators in accordance with the derived transport schedule.

According to another example embodiment, a computer program for managing access to one or more elevators of a building is provided is provided, the computer program comprising computer readable program code configured to cause performing at least the method according to the example embodiment described in the foregoing when said program code is executed on one or more computing apparatuses.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatuses at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some logical elements of an elevator system according to an example;

FIG. 2 illustrates a method according to an example; and

FIG. 3 schematically illustrates an apparatus according to an example.

### DESCRIPTION OF SOME EMBODIMENTS

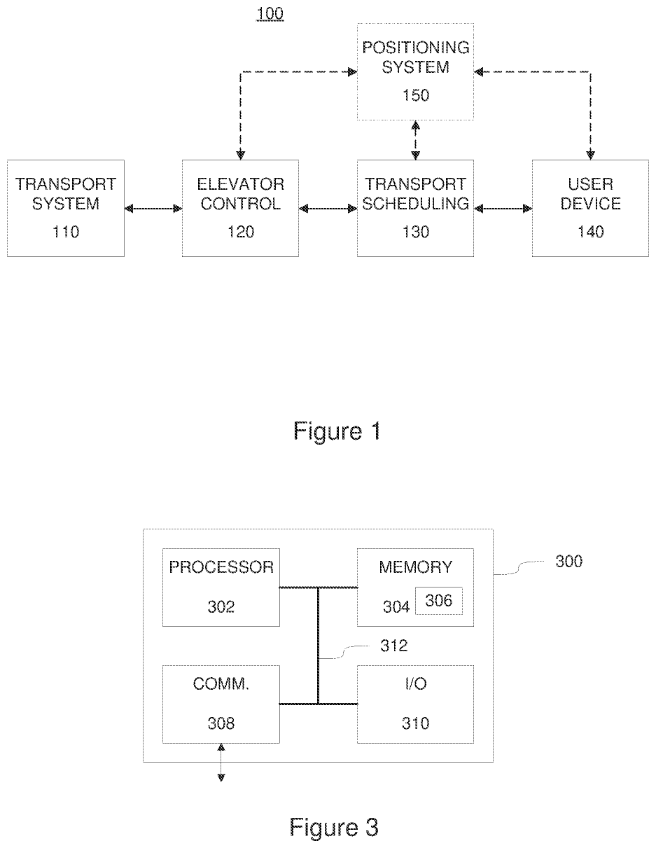

FIG. 1 illustrates a block diagram of some logical elements of an elevator system 100 according to an example. The elevator system 100 is shown in the example FIG. 1 with an elevator transport system 110 comprising one or more elevators for transporting passengers, an elevator controller 120 for controlling movement of the one or more elevators in accordance with a transport schedule, and an elevator transport scheduler 130 for deriving the transport schedule on basis of transport requests received thereat.

FIG. 1 further illustrates a user device 140 for interfacing the elevator system 100 via communicative coupling to the elevator transport scheduler 130, which may be provided e.g. using a suitable wireless communication network. The user device 140 is not strictly an element of the elevator system 100 but rather a device that may be coupled thereto for placing transport requests for transportation using the elevator transport system 110 and for receiving scheduling responses from the elevator system 100. For graphical clarity of illustration and description, the example of FIG. 1 shows only a single user device 140 and the examples in the foregoing (predominantly) refer to the user device 140 in singular, whereas in general case there may be a plurality of user devices 140 to enable their respective users to interface the elevator system 100.

The elevator system 100 may further comprise or it may be communicatively coupled to a positioning system 150 that operates to track respective positions of the user devices 140 and hence the respective locations of their users. The positioning system 150 may enable the user device 140 to obtain its current location and/or to enable one or more elements of the elevator system 100 to obtain current position of the user device 140. In this regard, the elements of the elevator system 100 that may obtain location information from the positioning system 150 may comprise the elevator controller 120 and/or the elevator transport scheduler 130. The positioning system 150 may enable, for example, deriving the floor in which the user device 140 currently resides and/or the current location of the user device 140 in the floor it currently resides. The positioning system 150 may comprise, for example, an indoor positioning system known in the art.

Along the lines described in the foregoing, the elevator transport system 110 comprises one or more elevators arranged for transporting one or more passengers. Typically, the elevator transport system 110 is installed in a building, which may be residential building, an office building, a public building (such as a library, museum, a sports venue, a station of public transportation, . . . ), etc. Alternatively, the elevator transport system 110 may be installed to serve a location that is not strictly a building, such as an underground station of public transportation or another venue or place of interest that is offset from the ground level.

In context of the present disclosure, an aspect of interest in relation to the elevator transport system 110 is the schedule of moving the elevator cars of the one or more elevators therein and, consequently, any aspects related to the structure and operation of the one or more elevators of the elevator transport system 110 may be provided using techniques known in the art and, consequently, any details pertaining to the structure and operation of the one or more elevators are described herein only to extent they are necessary for describing examples that pertain to receiving, processing and/or implementing transport requests originating from calls requesting transport using the one or more elevators.

The user device 140 may comprise a computing device such as a mobile phone (e.g. a smartphone), a tablet computer, a laptop computer, a desktop computer, etc. that is arranged to execute an elevator access application that serves as a user interface (UI) to the elevator system 100. In particular, in the course of a user activating, using or otherwise accessing the elevator access application in the user device 140, the elevator access application may operate to establish a connection to the elevator transport scheduler 130 (if not already in connection thereto) to enable transmitting a transport request to the elevator transport scheduler 130 and receiving a scheduling response from the elevator transport scheduler 130.

The elevator access application may be arranged to receive one or more aspects pertaining to a requested transport by the one or more elevators of the elevator transport system 110 via a UI of the user device 140, to compose a transport request in accordance with the information received via the UI, and to transmit the transport request to the elevator transport scheduler 130. The act of entering the one or more aspects for derivation of the transport request may be referred to as placing a transport call or simply as placing a call. Moreover, once the transport call has been placed, the person having placed the transport call may be considered as a passenger of the elevator system 100.

The information received via the UI from a passenger that constitutes a transport call and it comprises at least a destination floor and a requested transport time window for said passenger and the information may further comprise one or more of the following aspects:
Origin (source) floor of the passenger,
Call location (or request location),
Requested passenger group for the passenger.

Once having received the transport call via the UI, the elevator access application arranges the received aspects of the transport call into corresponding transport parameters of the transport request to be transmitted from the user device 140 to the elevator controller 120. Moreover, the elevator access application may complement the transport request with one or more transport parameters that are not received via the UI as part of the transport call. Yet further, the transport request may further comprise a device identifier (ID) assigned to the user device 140 or a component thereof, which device ID may subsequently serve to identify the passenger having placed the call that resulted in the transport request to the elevator system 100. Once completed, the elevator access application may cause the user device 140 to transmit the transport request to the elevator transport scheduler 130.

Along the lines described in the foregoing, the transport call received via the UI of the user device 140 may comprise an indication of the destination floor and, consequently, the elevator access application may cause the user device 140 to enter into the transport request a transport parameter that indicates the destination floor. The transport call may further comprise an indication of the origin floor and, consequently, the elevator access application may cause the user device 140 to enter into the transport request a transport parameter that indicates the origin floor. In case the origin floor is not received via the UI as part of the transport call, the elevator access application may employ the positioning system 150 available for the user device 140 (as described above) to derive the origin floor.

Along the lines described in the foregoing, the transport call received via the UI of the user device 140 may comprise an indication of the call location, e.g. the location of the passenger upon making the transport call and, consequently, the elevator access application may cause the user device 140 to enter into the transport request a transport parameter that indicates the call location. The call location may define the current floor of the passenger and/or the passenger's location in the respective floor. Typically, but not necessarily, the current floor is the same as the origin floor. The call location within a floor may be defined, for example, as coordinates with respect a predefined reference point (e.g. with respect to the location of access to the one or more elevators in the respective floor), as a room number, etc. In case the call location is not received via the UI as part of the transport call, the elevator access application may employ the positioning system 150 available for the user device 140 (as described above) to derive the call location as the current location of the user device 140.

Along the lines described in the foregoing, the transport call received via the UI of the user device 140 may comprise an indication of the requested transport time window and, consequently, the elevator access application may cause the user device 140 to enter into the transport request one or more transport parameters that indicate the requested transport time window. In this regard, the requested transport time window may specify a time period within which transport for the respective passenger is requested. In one example, the one or more transport parameters may indicate, for example, a starting time and an ending time of the requested transport time window, whereas in another example the one or more transport parameters may indicate the starting time together with a duration of the requested transport time window, thereby indirectly defining the ending time of the requested transport time window. The timing information pertaining to the requested transport time window may define each of the starting time and the ending time may be defined e.g. as an hour and minute of a day, whereas the timing information may include one or more further timing indications, e.g. one indicating a date to which the requested transport time window pertains or ones indicating a day of the week and/or a month of a year to which the requested transport time window pertains.

The duration of the time period defined via the requested transport time window may be chosen by the user 140. While in principle there is no upper limit for the duration of the requested transport time window, a typical duration of the requested transport time window be in a range from a few minutes to a few hours, e.g. in a range from 15 to 30 minutes. A specific example in this regard involves a transport time window where the ending time is the same as the starting time, resulting in transport time window duration of zero. Such a requested transport time window may be considered as a transport request that pertains to the specific time instant defined by the starting and ending times indicated for the requested transport time window.

The requested transport time window may pertain to a single elevator ride (e.g. on a certain day) or it may pertain to a series of elevator rides. An example of the latter comprises a request pertaining to a recurring elevator ride requested for the same time transport time window (defined as a certain time of a day) for a plurality of days. In this regard, the transport call received via the UI of the user device 140 may comprise an indication whether the request pertains to a single elevator ride or to a recurring elevator ride, whereas the elevator access application may case the user device 140 to enter this piece of information in the transport request.

Along the lines described in the foregoing, in the transport call received via the UI of the user device 140 may comprise an indication of the requested passenger group and, consequently, the elevator access application may cause the user device 140 to enter into the transport request a transport parameter that indicates the requested passenger group. As an example in this regard, the elevator access application may enable selecting the passenger group from a two or more predefined choices presented to the passenger on the UI. Instead of providing the passenger with a possibility to request a passenger group (e.g. one of the choices indicated via the UI), the indication of the requested passenger group may be pre-stored in the mobile device 140 (e.g. upon installing, configuring or updating the elevator access application for the respective passenger) and the transport parameter indicating the requested passenger group may be entered into the transport request accordingly.

As an example in this regard, the passenger grouping may be based on an aspect of health of the passengers, e.g. on respective body temperatures recorded for the passengers and/or on respective status indications concerning a predefined medical condition such as the Covid-19 infection or another medical condition arising from an infectious virus or bacteria. Consequently, using the status indications concerning a predefined medical condition as an example, the available passenger groups may comprise two or more of the following whereas the requested passenger group may indicate of them: the respective passenger has not suffered from the predefined medical condition, the respective passenger is currently suffering from the predefined medical condition, the respective passenger has recovered from the predefined medical condition. In another examples, the passenger grouping may be based e.g. on the age and/or on the gender of the passengers, whereas in a further example the passenger grouping may be based on an administrative policy, e.g. such that the passenger groups include two or more of the following: regular passengers, high-priority passengers, wheelchair-using passengers, maintenance personnel, etc.

After transmission of the transport request from the user device 140 to the elevator transport scheduler 130, the transport request is processed by the elevator transport scheduler 130 and one or more scheduling responses to acknowledge the transport request and/or to indicate the transport allocation derived for the respective passenger may be transmitted from the elevator transport scheduler 130 to the user device 140. Consequently, the elevator access application may operate to display information received in one or more scheduling responses to the passenger via the UI of the user device 140. Aspects related to operation of the elevator transport scheduler 130 accommodating the transport request to the transport schedule and deriving the one or more scheduling response as well as contents of the scheduling response are described via examples provided in the following.

Along the lines described in the foregoing, in the course of its operation the elevator transport scheduler 130 may receive respective transport requests from a plurality of user devices 140 and derive respective transport allocations for entry into the transport schedule. In other words, the elevator transport scheduler 130 may operate to derive and/or update the transport schedule on basis of the respective transport requests received from the plurality of user devices 140, where the transport requests received at the elevator transport scheduler 130 may convey the transport parameters described via the examples provided in the foregoing. In this regard, a transport request received at the elevator transport scheduler 130 comprises at least the device ID of the user device 140 applied for deriving the respective transport request and respective indications of the origin floor, the destination floor and the requested transport time window, whereas the transport request may further comprise respective indications of one or more of the following: the location of the transport call and/or the requested passenger group.

In addition to the transport requests received from the plurality of user devices 140, the elevator transport scheduler 130 may further receive respective transport calls entered via control panels arranged in an elevator lobby (or another space for accessing to the one or more elevators) and/or in the elevator cars of the one or more elevators. Such transport calls may be considered as respective ad hoc transport calls for requesting instantaneous transport by one of the one or more elevators. In this regard, the elevator transport scheduler 130 may enter respective transport allocations representing the ad hoc transport calls to the transport schedule in parallel with the transport allocations derived based on the transport requests received from the plurality of user devices 140.

The elevator transport scheduler 130 may comprise or may be provided using one or more computing devices comprising respective one or more processors arranged to execute one or more computer programs to provide at least some aspects of operation of the elevator transport scheduler 130. Hence, the elevator transport scheduler 130 may be provided as an elevator transport scheduling apparatus (e.g. using a single computer apparatus) or as an elevator transport scheduling system (e.g. using one or more computer apparatuses). According to an example, the elevator transport scheduler 130 may be communicatively coupled to the elevator controller 120, where the communicative coupling between the elevator transport scheduler 130 and the elevator controller 120 may be provided using a wired communication network, using a wireless communication network, or using a combination of a wired communication network and a wireless communication network. In another example, the elevator transport scheduler 130 may be provided as part of the elevator controller 120.

Along the lines described in the foregoing, the elevator controller 120 may be arranged to control movement of the one or more elevators in accordance with the transport schedule derived and/or maintained by the elevator transport scheduler 130. The elevator controller 120 may be arranged for controlling several aspects related to the operation of the one or more elevators of the elevator transport system 110 using techniques and/or procedures known in the art. Since in context of the present disclosure, an aspect of interest related to the elevator control is the scheduling of transport requests, other aspects related controlling operation of the one or more elevators of the elevator transport system 110 are described only to extent they are relevant for examples that pertain to operation of the elevator controller 120 in accordance with the transport schedule derived by the elevator transport scheduler 130.

The elevator controller 120 may comprise or may be provided using one or more computing devices comprising respective one or more processors arranged to execute one or more computer programs to provide at least some aspects of operation of the elevator controller 120. Hence, the elevator controller 120 may be provided as an elevator control apparatus (e.g. using a single computer apparatus) or as an elevator control system (e.g. using one or more computer apparatuses). The elevator controller 120 is communicatively coupled to the elevator transport system 110, where the communicative coupling between the elevator controller 120 and the elevator transport system 110 may be provided using a wired communication network, using a wireless communication network, or using a combination of a wireless communication network and a wireless communication network.

Referring back to operation of the elevator transport scheduler 130, the transport schedule derived and/or updated therein may include a respective transport allocation for a plurality of the transport requests received at the elevator transport scheduler 130 and, consequently, for a plurality of passengers having requested transport. The transport allocation entered in the transport schedule comprises at least a scheduled transport time derived for the respective transport request and it may comprise an identification of that one of the one or more elevators of the elevator transport system 110 allocated for the respective transport request (if applicable). Before deriving a respective transport allocation for a transport request, the elevator transport scheduler 130 may complement the transport parameters received in the respective transport request and/or modify one or more transport parameters received in the respective transport request to facilitate derivation of the respective transport allocation. The transport parameters received in a transport request together with the transport parameters possibly derived for the respective transport request at the elevator transport scheduler 130 may be referred to as transport parameters associated with the respective transport request.

Upon processing a received transport request, the elevator transport scheduler 130 may assign a request ID to the received transport request and derive the transport allocation for the respective transport request in dependence of at least some of the transport parameters associated therewith in view of the transport allocations (already) derived for one or more other passengers and in view of the transport capacity of the one or more elevators of the elevator transport system 110. Consequently, the elevator transport scheduler 130 may enter the derived transport allocation to the transport schedule, wherein the entry may include the request ID and/or the device ID received in the underlying transport request, at least some of the transport parameters received in the underlying transport request and/or transport parameters derived at the elevator transport scheduler 130 as well as the scheduled transport time derived for the respective transport request.

As an example of modifying or complementing the received transport request, in case the received transport request does not include the transport parameter that indicates the call (or request) location, the elevator transport scheduler 130 may apply the positioning system 150 to obtain the call location and complement the received transport request with the transport parameter that indicates the call location obtained via usage of the positioning system 150. In another example in this regard, the transport schedule may assume a predefined default location in the origin floor, e.g. the furthest point from the elevator lobby (or another space for accessing to the one or more elevators) in the respective floor or a center point of the origin floor and complement the received transport request with the transport parameter that indicates the call location as the default location.

Along the lines described in the foregoing, the elevator transport scheduler 130 may be arranged to derive a transport allocation for a passenger based on the transport request received for the respective passenger in view of transport requests received from one or more other passengers, in view of transport allocations derived for one or more other passengers and in view of the transport capacity of the one or more elevators of the elevator transport system 110. In this regard, the transport capacity of an elevator car may be defined as the maximum number persons allowed in the elevator car, in other words, as the number of places available in the elevator car. Due to transport allocations derived for other passengers based on transport requests received earlier, some of the places in one or more of the elevator cars of the elevator transport system 110 may be already allocated, whereas the remaining space in those elevator cars may be referred to as non-allocated places. Likewise due to transport allocations derived earlier, some of the elevator cars of the elevator transport system 110 may be already scheduled to move in a certain direction in the respective elevator shaft within the requested transport time window indicated in a transport request (if included). Consequently, an elevator car that is not yet scheduled to move in any direction or an elevator car that is scheduled to move in the direction from the origin floor to the destination floor indicated for the respective passenger at a time instant that falls within the requested transport time window indicated for the respective passenger may be considered as an elevator available for transporting the respective passenger from the origin floor to the destination floor indicated for the respective passenger.

According to an example, the derivation of a transport allocation for a passenger (and hence for the transport request received for the respective passenger) may aim at deriving the respective scheduled transport time and allocating one of the one or more elevators to the respective passenger via application of one or more predefined scheduling rules to allocate one of non-allocated places in those ones of the one or more elevators that are available for transporting the respective passenger from the origin floor to the destination floor indicated for the respective passenger in accordance with the timing of the requested transport indicated for the respective passenger.

Along the lines described in the foregoing, the elevator transport scheduler 130 may respond to the transport request received from the user device 140 via transmitting one or more scheduling responses to the user device 140, wherein the one or more scheduling responses may comprise one or more of the following:
a scheduling acknowledgement, which may serve as an indication of the elevator transport scheduler 130 having received the respective transport request;
a scheduling confirmation request, which may serve as a trigger to the user device 140 to respond to either confirm or cancel a transport request submitted earlier before the elevator transport scheduler 130 proceeds with derivation of the transport allocation based on the respective transport request;
a transport allocation indication, which may serve to indicate the scheduled transport time derived based on the respective transport request.

As an example in this regard, the elevator transport scheduler 130 may transmit the scheduling acknowledgement to the user device 140 in response to receiving a transport request therefrom to confirm reception of the transport request. In such a scenario, the scheduling acknowledgement may include the request ID assigned for the underlying transport request while the scheduling acknowledgment may or may not include further information associated with the upcoming transport allocation. Hence, the scheduling acknowledgement may serve to inform the user device 140 that the transport request has been received at the elevator transport scheduler 130 for subsequent derivation of the transport allocation and for entry to the transport schedule, whereas further information associated with the upcoming transport allocation may be transmitted to the user device 140 after the transport request has been allocated into the transport schedule will provide further information of the allocated transport.

According to an example, the elevator transport scheduler 130 may proceed with deriving the transport allocation based on a transport request received thereat substantially immediately after having received the transport request or at a later time. In the former scenario, the elevator transport scheduler 130 may refrain from transmitting a scheduling confirmation request to the user device 140 and proceed directly to derivation of the transport allocation (and subsequent transmission of the transport allocation indication). In the latter scenario, the elevator transport scheduler 130 may transmit a scheduling confirmation request (that may include the request ID) to the user device 140, whereas the user device 140 may respond to the scheduling confirmation request by confirming or by cancelling the transport request. In this regard, the user device 140 may display a request to one of confirm or cancel the transport request via its UI and transmit, to the elevator transport scheduler 130, a message that indicates one of confirmation or cancellation of the transport request in accordance with user input received via the UI of the user device 140, whereas the elevator transport scheduler 130 may one of proceed with derivation of the transport allocation or cancel derivation of the transport allocation accordingly.

As an example of timing of derivation of the transport allocation, the elevator transport scheduler 130 may proceed with deriving the transport allocation at a time instant that is at least by a predefined time margin before the requested transport time window indicated in the transport request. In case the requested transport time window is already closer than the predefined time margin upon receiving the transport request, the elevator transport scheduler 130 may proceed with derivation of the transport allocation without transmitting the scheduling confirmation request and receiving an affirmative response thereto, whereas in case the time delay between reception of the transport request and the requested transport time window is longer than the predefined time margin, the elevator transport scheduler 130 may carry out the procedure that involves transmission of the scheduling confirmation request to and reception of the confirmation from the user device 140 (described above) before proceeding with derivation of the transport allocation. Such a transport request that is waiting at the elevator transport controller 130 for subsequent derivation of the respective transport allocation may be referred to as a pending transport request, whereas the elevator transport scheduler 130 may take the pending transport requests into consideration when deriving a transport allocation for a given transport request. As an example, the predefined time margin may be a suitable value chosen from a range from a couple of minutes to half an hour, e.g. 15 minutes.

Deriving the transport allocations at the time instant that precedes the respective requested transport time window by the predefined time margin instead of proceeding with derivation of the transport allocation immediately after reception of the respective transport request (unless already within the time margin) may be advantageous in scenarios where a number of transport requests are received well in advance of the respective requested transport time windows, thereby enabling the elevator transport scheduler 130 also to account for the pending transport requests upon deriving the transport allocation for a given transport request.

Once the transport allocation for a transport request has been derived, the elevator transport scheduler 130 may proceed with transmitting the transport allocation indication to the user device 140 having transmitted to the respective transport request. The transport allocation indication may include the scheduled transport time derived based on the respective transport request, whereas the transport allocation indication may further include the request ID assigned to the respective transport request and/or an identification of the elevator allocated to serve the respective transport request.

In case the elevator transport scheduler 130 is not able to accommodate a transport allocation matching a transport request into to the transport schedule, in an example, the elevator transport scheduler 130 may cancel the respective transport request and transmit an indication in this regard to the user device 140 from which the respective transport request has been received, thereby providing the user device 140 with an indication of a failure to accommodate the requested elevator transport into the transport schedule. Such indication may be referred to as an allocation failure indication and it may comprise at least the respective request ID. In another example, the elevator transport scheduler 130 may proceed from a failure to derive a transport allocation within the requested transport time indicated in the respective transport request by deriving one or more tentative transport allocations that pertain to respective one or more tentative transport times that are outside the requested transport time window but that are as close as possible to the requested transport time window. In this regard, the one or more tentative transport times may include a first tentative transport time that is scheduled before the requested transport time window and/or a second tentative transport time that is scheduled after the requested transport time window. Consequently, the transport allocation indication transmitted from the elevator transport scheduler 130 to the user device 140 may include the one or more tentative transport times, whereas the user device 140 may respond to such transport allocation indication by confirming one of the one or more tentative transport times included in the transport allocation indication or by cancelling the transport request. In this regard, the user device 140 may display a request to one of confirm one of the one or more tentative transport times or cancel the transport request via its UI and transmit, to the elevator transport scheduler 130, a message that indicates the selection received via the UI, whereas the elevator transport scheduler 130 may confirm and/or cancel the one or more tentative transport allocations accordingly.

According to an example, the one or more scheduling rules the elevator transport scheduler 130 applies for derivation of the transport allocations may aim at distributing the transport allocations received thereat as evenly as possible over time in consideration of the respective transport time windows indicated in the received transport requests. This may be accomplished, for example, via distributing the transport allocations over time such that the number of non-allocated places across the one or more elevators remains as uniform as possible (e.g. such that the number of non-allocated places across the one or more elevators is kept substantially the same over time). In one example, the one or more scheduling rules may consider one transport request at a time via allocating, for the respective passenger, one of the non-allocated places in the one or more elevators that are available for transporting the respective passenger such that the number of non-allocated places across the one or more elevators over time remains as uniform as possible. In another example, the one or more scheduling rules may consider a plurality of transport request at a time via allocating, for each of the respective passengers, one of the non-allocated places in the one or more elevators that are available for transporting the respective passenger such that the number of non-allocated places across the one or more elevators remains over time as uniform as possible. While considering the transport requests one at a time (e.g. the former example) may result in a lower-computation (e.g. simpler) procedure for deriving the transport allocation, consideration of a plurality of transport request jointly (e.g. the latter example) may result in allocating the transport requests in a more uniform manner with the cost of an increased amount of computation.

In this regard, allocating the transport requests to the transport schedule in view of the respective requested transport time windows instead of allocating them at or as close as possible to a certain requested transport time instant provides flexibility in serving the transport requests without unduly compromising the service quality. In particular, allocating the transport requests as uniformly as possible over time provides an advantage of keeping the load of the elevator transport system 110 (in terms of the number of passengers served per time unit) substantially constant over time, which in turn allows for further freedom in the elevator transport scheduler 130 allocating upcoming transport requests into the transport schedule and/or in serving ad hoc transport calls in parallel with the transport requests allocated into the transport schedule, thereby enabling improved usage of the transport capacity of the elevator transport system 110 while in case of relatively high load of the elevator transport system 110 also leading in minimizing waiting times the passengers are experiencing. This approach may be especially beneficial in typical peak hours of the elevator transport system 110, such as around beginnings and endings of business hours as well as during lunch hours in an office building.

According to another example, additionally or alternatively, the one or more scheduling rules the elevator transport scheduler 130 applies for derivation of the transport allocations may aim at minimizing the number of stops across the one or more elevators of the elevator transport system 110 in consideration of the respective origin floors and destination floors indicated in the respective transport requests. As an example in this regard, in consideration of a single transport request, the one or more scheduling rules may allocate, for the respective passenger, one of the non-allocated places in the one or more elevators that are available for transporting the respective passenger within the requested transport time window such that the number of additional stops introduced in the elevator transport system 110 is minimized in consideration of the origin floor and the destination floor indicated in the respective transport request. Herein, minimizing the number of additional stops may be accomplished via identifying a non-allocated place in an applicable elevator that is already scheduled to move in a requested direction and that is already scheduled to stop at the origin floor and/or at the destination floor indicated in the respective transport request.

In this regard, allocating the transport requests with the aim of minimizing the number of stops across the one or more elevators is advantageous in that in a typical scenario an increasing number of stops is a major contributor in increasing the load of the elevator transport system 110 and, conversely, minimizing the number of stops contributes towards keeping the load of the elevator transport system 110 as low as possible in view of the received transport requests. In this regard, allocating the transport requests to the transport schedule in view of the respective requested transport time windows instead of allocating them at or as close as possible to a certain requested transport time instant provides further freedom in keeping the number of stops across the one or more elevators as small as possible while still serving the transport requests without unduly compromising the service quality. This, in turn, serves to ensure that the elevator transport scheduler 130 has further freedom in allocating upcoming transport requests into the transport schedule and/or in serving ad hoc transport calls in parallel with the transport requests allocated into the transport schedule without unduly increasing the load of the elevator transport system 110.

The examples described in the foregoing assume that all elevators of the elevator transport system 110 are available for transport allocations derived via operation of the one or more scheduling rules, in other words assume that each of the one or more elevators is available for the transport allocations regardless of a time of a day, a day of the week, a month of the year, a day of the year, etc. and/or load of the elevator transport system 110. In further examples, the elevator transport scheduler 130 may select the elevators for consideration by the one or more scheduling rules in dependence of time (e.g. a time of the day, a day of the week, a month of the year and/or a day of the year) and/or in dependence of the load of the elevator system 100. As an examples in this regard, a (first) predefined subset of the one or more elevators may be available for transport allocations during one or more predefined time periods whereas all of the one or more elevators may be available for transport allocations outside the one or more predefined time periods, where each of the one or more predefined time periods may define one or more of the following: a respective time of the day, a respective day of the week, a respective month of the year, a respective day of the year. In other examples, a (second) predefined subset of the one or more elevators may be available for transport allocations in a situation where an observed load of the elevator transport system 110 (in terms of the number of passengers served per time unit) below a predefined threshold whereas all of the one or more elevators may be available for transport allocations when the observed load is larger than or equal to the predefined threshold. While such time dependent and/or load dependent limitations to the number of elevators available for transport allocations may result in increased waiting times for many passengers, on the other hand it may enable significant energy savings via usage of a smaller number of elevators serving the transport requests during periods when a relatively low number of passengers is expected and/or observed.

In the examples described in the foregoing, the derivation of the transport allocation for a passenger based on the transport request received from the user device 140 of the passenger (implicitly) considers all passengers as a single group, whereas according to another example the derivation of the transport allocation for a passenger may further comprise passenger grouping described in the foregoing. In other words, a passenger may be assigned into one of a plurality of (e.g. two or more) passenger groups, whereas the passenger group into which the respective passenger is assigned may have an effect on derivation of the transport allocation for the respective passenger.

Along the lines described in the foregoing, the user grouping may be based on an aspect of health of the passengers, e.g. on body temperatures recorded for the passengers and/or on status indications concerning a predefined medical condition such as the Covid-19 infection or another medical condition arising from an infectious virus or bacteria. Using the status indications concerning a predefined medical condition as an example, each of the passenger groups may represent a respective status with respect to the predefined medical condition, for example one of the following: passengers that have not suffered from the predefined medical condition, passengers that are currently suffering from the predefined medical condition, passengers that have recovered from the predefined medical condition. As a non-limiting example concerning the passenger grouping, the assignment into the plurality of passenger groups may be based on a technique described in the co-pending international patent application no. PCT/FI2020/050366. While the grouping described therein refers, for example, to assignment of a plurality of occupants (of a building) into a plurality of occupant groups based on one or more occupant characteristics pertaining to the health of the recorded to the occupants, the grouping of PCT/FI2020/050366 is applicable in context of the present disclosure as well, mutatis mutandis.

Still referring to the aspect of deriving the transport allocation for a passenger in consideration of passenger grouping, the respective transport request received at the elevator transport scheduler 130 may include the transport parameter that indicates the passenger group for the respective passenger, whereas in case the received transport request does not include the transport parameter that indicates the passenger group for the respective passenger, the elevator transport scheduler 130 may complement the respective transport request by such transport parameter that indicates the passenger group into which the respective passenger is assigned to. The grouping information may be available for the transport scheduler 130 via a health information database that stores pre-recorded health information for the plurality of passengers and the elevator transport scheduler 130 may assign a passenger requesting transport into one of the plurality of passenger groups along the lines described in PCT/FI2020/050366 and complement the respective transport request with the transport parameter that indicates the passenger group to which the respective passenger is assigned. In another example, the elevator transport scheduler 130 may have access to a passenger group database that stores pre-recorded passenger group information that may be applied by the elevator transport scheduler 130 to complement the transport request with the transport parameter that indicates the passenger group to which the respective passenger is assigned. The health information database and/or the passenger group database may be available, for example, in a memory accessible by the elevator transport scheduler 130 or the health information database and/or the passenger group database may be available via another entity of the elevator system 100 or via an element communicatively coupled to the elevator system 100.

With the knowledge of the passenger group into which a passenger is assigned, the elevators considered to be available for transporting the respective passenger in derivation of the transport allocation for the respective passenger may be defined in dependence of the passenger group indicated for the respective passenger. As an example in this regard, at least one of the one or more elevators of the elevator transport system 110 may be defined to be available for transporting only passengers of certain passenger groups at least during one or more predefined time windows, whereas in another example at least one of the one or more elevators of the elevator transport system 110 may be defined to be unavailable for transporting passengers of certain passenger groups at least during one or more predefined time windows.

Non-limiting examples of defining availability and/or unavailability of certain elevators for certain passenger groups include the following:
A subset (i.e. less than all) of the one or more elevators may be defined to be available only for a predefined subset (i.e. less than all) of the passenger groups until further notice;
A subset (i.e. less than all) of the one or more elevators may be defined to be unavailable for a predefined subset (i.e. less than all) of the passenger groups until further notice;
A subset (i.e. less than all) of the one or more elevators may be defined to be available only for a predefined subset (i.e. less than all) of the passenger groups during one or more predefined time windows;
A subset (i.e. less than all) of the one or more elevators may be defined to be unavailable for a predefined subset (i.e. less than all) of the passenger groups during one or more predefined time windows.

Consequently, in context of the derivation of the transport allocation for a passenger, the elevators that are defined as available for transporting passengers of the passenger group indicated for the respective passenger and/or the elevators that are not defined as unavailable for transporting passengers of the passenger group indicated for the respective passenger during the time period of interest are considered as elevators available for transporting the respective passenger.

Depending on the applied confirmation/definition, the availability and/or unavailability of at least one of the one or more elevators of the elevator transport system 110 at least during one or more predefined time windows may be applied, for example, to avoid mixing passengers of a first passenger group with passengers of a second passenger group in elevator cars of the one or more elevators or in the elevator lobby (or another space for accessing the one or more elevators). As a non-limiting example, such an approach may be applied to avoid mixing passengers currently suffering from a predefined medical condition with passengers that that have not yet suffered from the predefined medical condition.

Information that defines the availability and/or unavailability of at least one of the one or more elevators of the elevator transport system 110 at least during one or more predefined time windows may be stored in a memory accessible by the elevator transport scheduler 130 and it may be configured or adjusted in the course of operation of the elevator system 100. Hence, an operator of the elevator system 100 may adjust the respective availability and/or unavailability of the one or more elevators and the temporal applicability of such restrictions to availability of the one or more elevators according to current usage scenario.

The health-based grouping described above serves as a non-limiting example of applicable grouping, whereas in other example the grouping may be based e.g. on the age and/or on the gender of the passengers. In further examples, the grouping may rely in respective transport priorities assigned to two or more passenger groups, where a transport priority assigned to a certain passenger group may reflect a relative importance assigned to the respective passenger group. In this regard, the transport priorities may be applied to define relative importance of transport requests originating from two or more of the following passenger groups: regular passengers, high-priority passengers, wheelchair-using passengers, maintenance personnel, autonomous devices (such as robots that are able to make use of elevator transport and communicate with the elevator transport scheduler via a suitable application programmable interface (API)), etc.

In one example, the priority-based grouping may be applied in a similar manner as described above for the health-based grouping, mutatis mutandis, i.e. via defining a first subset of the one or more elevators to be available only for a first subset of passenger groups and/or via defining a second subset of the one or more elevators to be non-available for a second subset of passenger groups. In another example, priority-based grouping may be applied such that the elevator transport scheduler 130 may serve the transport requests in an order that depends on the respective transport priorities indicated in the transport requests under consideration. In an example of such an approach the elevator transport scheduler 130 may derive respective transport allocations for transport requests for which a higher transport priority is indicated before deriving respective transport allocations for transport requests for which a lower transport priority is indicated. Thus, in case a plurality of transport requests are pending for derivation of the respective transport allocations, the elevator transport scheduler 130 may derive respective transport allocations for those transport requests for which a higher transport priority is indicated before proceeding into derivation of respective transport allocations for those transport requests for which a lower transport priority is indicated.

Once the elevator transport scheduler 130 has derived the transport allocation for a transport request and hence for a passenger having placed the transport call that triggered the respective transport request, the elevator transport scheduler 130 may store the transport allocation to the transport schedule or otherwise make a corresponding entry to the transport schedule. In this regard, the transport allocation entered to the transport schedule may comprise the request ID and/or the device ID received in the underlying transport request, the origin floor and the destination floor associated with the underlying transport request as well as the scheduled transport time and an indication of the elevator allocated for the respective passenger (if applicable). Moreover, the elevator transport scheduler 130 may transmit at least some of the information stored in the transport schedule entry in the scheduling response to the user device 140 from which the respective transport request originates. In this regard, the scheduling response comprises at least the scheduled transport time and it may comprise respective indications of the request ID, the elevator allocated for the respective passenger (if applicable), the origin floor and/or the destination floor.

According to an example, the derivation of the transport allocation may fail to identify an available elevator matching a transport request and, consequently, tail to derive the scheduled transport time for the respective transport request. Consequently, the elevator transport scheduler 130 refrains from making a respective entry to the transport schedule and the elevator transport scheduler 130 may either refrain from transmitting a scheduling response to the user device 140 or it may transmit a scheduling response that indicates a failure to accommodate the transport request received from the user device 140 instead of indicating the scheduled transport time.

Upon receiving the scheduling response from the elevator transport scheduler 130, the elevator access application in the user device 140 may operate to display the information received in the scheduling response via the UI of the user device 140 to the passenger, who then has either the knowledge of the scheduled pick up time at the elevator lobby (or another space for accessing the one or more elevators) or the knowledge of a failure to accommodate the requested transport. Consequently, in case of successful scheduling of the transport request by the elevator transport scheduler 130, the passenger is expected to arrive at the elevator lobby for pick up by the assigned elevator at the scheduled transport time.

According to an example, the elevator access application in the user device 140 may provide the passenger with a possibility to cancel the transport request via the UI of the user device 140 in view of the received scheduling response. In case the passenger chooses to cancel the transport scheduled for her/him, the elevator access application in the user device 140 may operate to transmit a cancellation message to the elevator transport scheduler 130 to indicate the cancellation by the passenger, and the elevator transport scheduler 130 may remove the corresponding entry from the transport schedule.

According to an example, following a successful scheduling of a transport request, the passenger may be required to register his/her presence in the elevator lobby (or another space for accessing the one or more elevators) by the scheduled transport time. In this regard, a timely registration may require arrival at the elevator lobby at least a predefined time period before the scheduled transport time (where the time period may be a predefined value, for example, in a range from a few seconds to a few tens of seconds). As an example, the registration may be carried out in response to user input received via the UI of the user device 140 executing the elevator access application (e.g. via the elevator access application transmitting a registration message to the elevator transport scheduler 130), whereas in another example the elevator access application in the user device 140 may apply the positioning system 150 to track the location of the user device 140 and it may automatically register presence of the user device 140 (and hence presence of the passenger) in the elevator lobby with the elevator transport scheduler 130. In a further example, the transport scheduler 130 may apply the positioning system 150 to track the location of the user device 140 (at least within a time period preceding the scheduled transport time of the respective passenger) and automatically register presence of the user device 140 in the elevator lobby in response to the positioning system 150 reporting its location in the elevator lobby.

In response to a timely registration, the elevator assigned to the passenger will make a stop at the origin floor according to the scheduled transport time, whereas in response to a lack of timely registration the elevator transport scheduler 130 may cancel or remove the corresponding transport allocation from the transport schedule and, consequently, the elevator assigned for the passenger may not stop at the origin floor unless there are one or more other passengers waiting for pick up at their respective scheduled transport times.

According to an example, the elevator system 100 may comprise or it may be coupled to one or more display devices arranged in the elevator lobby, which one or more display devices may be applied for displaying information relating to operation of the one or more elevators of the elevator transport system 110. The information shown via the one or more display devices may be controlled by an element of the elevator system 100, e.g. the elevator controller 120. The information shown via the one or more display devices may comprise information that serves to assist a passenger arriving the elevator lobby to identify the one of the elevators assigned for him/her, for example respective indications of traveling direction(s) of the one or more elevators and/or respective scheduled stops for the one or more elevators.

In the examples described in the foregoing, the derivation of the transport schedule relies on the transport requests received from the user devices 140, thereby, in a way, describing an approach that relies on transport requests received in advance. Along the lines described in the foregoing, the elevator system 100 may further enable ‘traditional’ placement of transport calls (i.e. ad hoc transport calls) via a passenger operating the control panel (or a call giving device of other type) provided in the elevator lobby (or another space for accessing the one or more elevators) or in an elevator car that may enable requesting transport up or down and/or to a destination floor specified upon placing the transport request. In one example, the coexistence between transport requests made in advance via a plurality of user devices 140 may be provided via the elevator transport scheduler 130 accommodating the ad hoc transport calls into the transport schedule in view of the existing transport allocations recorded therein, whereas in another example such coexistence of the transport requests received in advance and ad hoc transport requests may be provided by dedicating at least one of the one or more elevators of the elevator transport system 110 for serving the ‘ad-hoc’ calls.

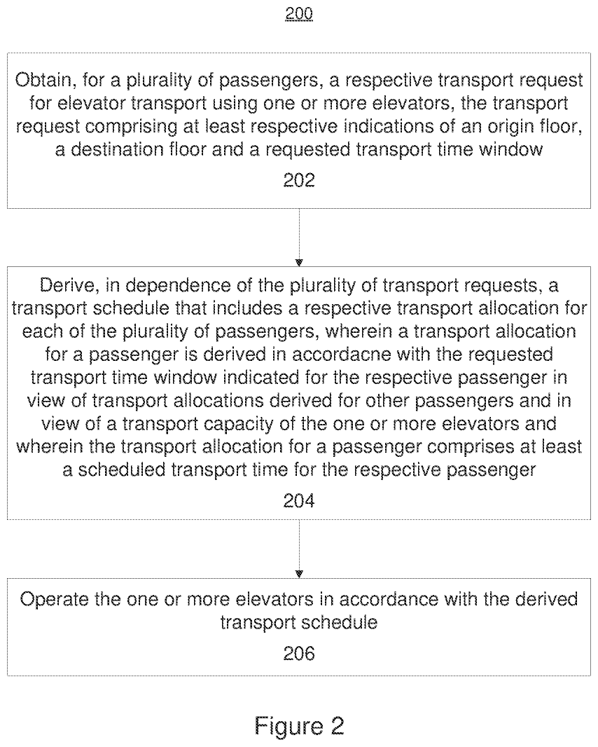

The operations pertaining to derivation of the transport schedule in the elevator transport scheduler 130 may be described as steps of a method. As an example in this regard, FIG. 2 depicts a flowchart illustrating a method 200, which may be carried out in the elevator transport scheduler 130 or in another element of the elevator system 100 in the course of its operation. The method 200 commences from obtaining for a plurality of passengers, a respective transport request for elevator transport using the one or more elevators, the transport request comprising at least respective indications of an origin floor, a destination floor and a requested transport time, as indicated in block 202. The method 200 further comprises deriving, in dependence of the plurality of transport requests, a transport schedule that includes a respective transport allocation for each of the plurality of passengers, wherein a transport allocation for a passenger is derived in view of transport allocations derived for other passengers and in view of a transport capacity of the one or more elevators and wherein the transport allocation for a passenger comprises at least a scheduled transport time for the respective passenger, as indicated in block 204. The method 200 further comprises operating the one or more elevators in accordance with the derived transport schedule. Respective operations described with references to blocks 202 to 206 pertaining to the method 200 may be implemented, varied and/or complemented in a number of ways, for example as described with references to components of the elevator system 100 in the foregoing and/or in the following.

Along the lines described in the foregoing, the elevator transport scheduler 130 may comprise or may be provided using one or more computing devices comprising respective one or more processors arranged to execute one or more computer programs to provide at least some aspects of operation of the elevator transport scheduler 130. As an example in this regard, the operation of the elevator transport scheduler 130 may be provided by an elevator transport scheduler apparatus or as an apparatus arranged to operate as the elevator transport scheduler 130. FIG. 3 schematically illustrates some components of an apparatus 300 that may be employed to implement such an apparatus.

The apparatus 300 comprises a processor 310 and a memory 320. The memory 320 may store data and computer program code 325. The apparatus 300 may further comprise communication means 330 for wired or wireless communication with other apparatuses and/or user I/O (input/output) components 340 that may be arranged, together with the processor 310 and a portion of the computer program code 325, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 300 are communicatively coupled to each other via a bus 350 that enables transfer of data and control information between the components.

The memory 320 and a portion of the computer program code 325 stored therein may be further arranged, with the processor 310, to cause the apparatus 300 to perform at least some aspects of operation of the elevator transport scheduler 130 described in the foregoing. The processor 310 is configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement at least some aspects of operation of the elevator transport scheduler 130 described in the foregoing when loaded into the processor 410. As an example, the computer program code 425 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus 300 to perform at least some aspects of operation of the elevator transport scheduler 130 described in the foregoing. Hence, the apparatus 300 may comprise at least one processor 310 and at least one memory 320 including the computer program code 325 for one or more programs, the at least one memory 320 and the computer program code 325 configured to, with the at least one processor 310, cause the apparatus 300 to perform at least some aspects of operation of the elevator transport scheduler 130 described in the foregoing.

The computer program code 325 may be provided e.g. a computer program product comprising at least one computer-readable non-transitory medium having the computer program code 325 stored thereon, which computer program code 325, when executed by the processor 310 causes the apparatus 300 to perform at least some aspects of operation of the elevator transport scheduler 130 described in the foregoing. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

1. An apparatus for scheduling elevator transport in an elevator system comprising one or more elevators, the apparatus configured to:
obtain, for a plurality of passengers, a respective transport request for elevator transport using said one or more elevators, the transport request comprising at least respective indications of an origin floor, a destination floor and a requested transport time window;
derive, in dependence of said plurality of transport requests, a transport schedule that includes a respective transport allocation for each of said plurality of passengers, wherein a transport allocation for a passenger is derived in accordance with the requested transport time window indicated for the respective passenger, in view of transport allocations derived for other passengers and in view of a transport capacity of said one or more elevators and wherein the transport allocation for a passenger comprises at least a scheduled transport time for the respective passenger; and
operate said one or more elevators in accordance with the derived transport schedule,
wherein the apparatus is configured to derive the transport allocation for a passenger via deriving the scheduled transport time for the respective passenger via application of one or more predefined scheduling rules arranged to allocate one of non-allocated places in those ones of said one or more elevators that are available for transporting the respective passenger in accordance with the transport request obtained for the respective passenger, wherein the one or more elevators under consideration by the one or more scheduling rules are selected in dependence of time and/or load of the elevator system.

2. The apparatus according to claim 1, configured to derive the transport allocation for a passenger via deriving the scheduled transport time for the respective passenger at least in dependence of the origin floor, the destination floor and the requested transport time window indicated for the respective passenger.

3. The apparatus according to claim 1,
wherein the transport allocation for a passenger further comprises an identification of an elevator of said one or more elevators assigned for the respective passenger, and
wherein the apparatus is configured to derive the transport allocation via assigning one of said one or more elevators for transporting the respective passenger at least in dependence of the origin floor, the destination floor and the requested transport time window indicated for the respective passenger.

4. The apparatus according to claim 1, wherein at least one of the following applies:
said one or more predefined scheduling rules are arranged for distributing transport allocations evenly over time in consideration of the respective transport time windows indicated in said plurality of transport requests; and
said one or more predefined scheduling rules are arranged for allocating, for the respective passenger, one of said non-allocated places within the requested transport time window such that the number of non-allocated places across the one or more elevators over the transport time window indicated for the respective passenger remains as uniform as possible.

5. The apparatus according to claim 4, wherein said one or more predefined scheduling rules are arranged for distributing transport allocations over time such that the number of said non-allocated places across the one or more elevators over time remains as uniform as possible.

6. The apparatus according to claim 1, wherein said one or more predefined scheduling rules are arranged for minimizing the number of additional stops introduced in the elevator system in consideration of the respective origin floors, the respective destination floors and the respective transport time windows indicated in said plurality of transport requests.

7. The apparatus according to claim 1, wherein said one or more predefined scheduling rules are arranged for allocating, for the respective passenger, one of said non-allocated places within the requested transport time window that the number of additional stops introduced in the elevator system is minimized in consideration of the origin floor and the destination floor indicated in the respective transport requests.

8. The apparatus according to claim 1,
wherein said plurality of transport request further comprise a respective indication of one of a plurality of passenger groups into which the respective passenger is assigned, and
wherein said one or more predefined scheduling rules are arranged for deriving respective transport allocations for said plurality of transport requests in consideration of the respective passenger groups indicated in said plurality of transport requests.

9. The apparatus according to claim 8, wherein said plurality of passenger groups comprise two or more passenger groups, where each passenger group represents passengers having a respective status with respect to a predefined medical condition.

10. The apparatus according to claim 9, wherein said two or more passenger groups comprise two or more of the following passenger groups:
passengers not having suffered from said medical condition;
passengers currently suffering from said medical condition; and
passengers recovered from said medical condition.

11. The apparatus according to claim 1, wherein the apparatus is configured to cancel a transport allocation derived for a passenger in response to not having registered presence of said passenger in a space for accessing the one or more elevators by a predefined time margin before the scheduled transport time of said respective passenger.

12. The apparatus according to claim 11, wherein the apparatus is configured to:
track the location of a user device of said passenger; and
cancel the transport allocation derived for said passenger in response to not having detected presence of said user device in the space for accessing the one or more elevators by the predefined time margin before the scheduled transport time of said respective passenger.

13. An elevator system comprising the apparatus according to claim 1.

14. A method for scheduling elevator transport in an elevator system comprising one or more elevators, the method comprising the steps of:
obtaining, for a plurality of passengers, a respective transport request for elevator transport using said one or more elevators, the transport request comprising at least respective indications of an origin floor, a destination floor and a requested transport time window;
deriving, in dependence of said plurality of transport requests, a transport schedule that includes a respective transport allocation for each of said plurality of passengers, wherein a transport allocation for a passenger is derived in accordance with the requested transport time window indicated for the respective passenger, in view of transport allocations derived for other passengers and in view of a transport capacity of said one or more elevators and wherein the transport allocation for a passenger comprises at least a scheduled transport time for the respective passenger; and
operating said one or more elevators in accordance with the derived transport schedule,
wherein deriving the transport allocation for a passenger comprises deriving the scheduled transport time for the respective passenger via application of one or more predefined scheduling rules arranged to allocate one of non-allocated places in those ones of said one or more elevators that are available for transporting the respective passenger in accordance with the transport request obtained for the respective passenger, wherein the one or more elevators under consideration by the one or more scheduling rules are selected in dependence of time and/or load of the elevator system.

15. A computer program comprising computer readable program code embodied on a non-transitory computer readable medium and configured to perform the method according to claim 14 when said program code is run on one or more computing apparatuses.

16. The apparatus according to claim 2,
wherein the transport allocation for a passenger further comprises an identification of an elevator of said one or more elevators assigned for the respective passenger, and
wherein the apparatus is configured to derive the transport allocation via assigning one of said one or more elevators for transporting the respective passenger at least in dependence of the origin floor, the destination floor and the requested transport time window indicated for the respective passenger.

17. The apparatus according to claim 2, wherein at least one of the following applies:
said one or more predefined scheduling rules are arranged for distributing transport allocations evenly over time in consideration of the respective transport time windows indicated in said plurality of transport requests; and
said one or more predefined scheduling rules are arranged for allocating, for the respective passenger, one of said non-allocated places within the requested transport time window such that the number of non-allocated places across the one or more elevators over the transport time window indicated for the respective passenger remains as uniform as possible.

18. The apparatus according to claim 3, wherein at least one of the following applies:
said one or more predefined scheduling rules are arranged for distributing transport allocations evenly over time in consideration of the respective transport time windows indicated in said plurality of transport requests; and
said one or more predefined scheduling rules are arranged for allocating, for the respective passenger, one of said non-allocated places within the requested transport time window such that number of non-allocated places across the one or more elevators over the transport time window indicated for the respective passenger remains as uniform as possible.

19. The apparatus according to claim 2, wherein said one or more predefined scheduling rules are arranged for minimizing the number of additional stops introduced in the elevator system in consideration of the respective origin floors, the respective destination floors and the respective transport time windows indicated in said plurality of transport requests.

20. The apparatus according to claim 3, wherein said one or more predefined scheduling rules are arranged for minimizing the number of additional stops introduced in the elevator system in consideration of the respective origin floors, the respective destination floors and the respective transport time windows indicated in said plurality of transport requests.
